(19) United States
(12) Patent Application Publication
(10) Pub. No.: US 2013/0148052 A1
(43) Pub. Date: Jun. 13, 2013

(54) Backlight Module and LCD Device

(71) Applicants: Chong Huang, Shenzhen City (CN); Shih-Hsiang Chen, Shenzhen City (CN)

(72) Inventors: Chong Huang, Shenzhen City (CN); Shih-Hsiang Chen, Shenzhen City (CN)

(73) Assignee: Shenzhen China Star Optoelectronics Technology Co., LTD., Shenzhen City, Guangdong (CN)

(21) Appl. No.: 13/381,077

(22) PCT Filed: Dec. 14, 2011
(86) PCT No.: PCT/CN2011/084014

§ 371 Date: Dec. 27, 2011

(30) Foreign Application Priority Data
Dec. 13, 2011 (CN) 201110415208.6

(51) Int. Cl. G02F 1/13357; F21V 29/00; G09F 13/04

(52) U.S. Cl. 349/61; 362/97.1; 345/102

(57) ABSTRACT

A backlight module is disclosed, which comprises a light source device, a heat dissipating device and a backplate. The heat dissipating device is disposed between the light source device and the backplate and makes contact with the light source device and the backplate respectively. The heat dissipating device comprises a heat dissipating body and a plurality of heat dissipating units disposed on the heat dissipating body respectively. The backplate comprises a plurality of openings, through which the plurality of heat dissipating units extend respectively. An LCD device comprising the backlight module is further disclosed.

### FIELD OF THE INVENTION

The present disclosure generally relates to the field of flat panel displays, and more particularly, to a backlight module (BLM) having a high heat dissipation efficiency and a liquid crystal display (LCD) device comprising the backlight module.

### BACKGROUND OF THE INVENTION

Owing to their advantages such as having a low radiation level, a light weight, a thin profile and low power consumption, LCD devices have found wide applications in mobile phones, personal digital assistants (PDAs), notebook computers, personal computers (PCs), TV sets and the like. Because liquid crystal molecules in an LCD panel do not emit light by themselves, an area light source device (e.g., a backlight module) must be provided for the LCD panel in order to accomplish the displaying function. The area light source device is mainly used to provide an area light source with sufficient and uniformly distributed luminance for the LCD panel.

In order to satisfy the requirements on energy consumption, durability and environmental protection, high-performance light emitting diodes (LEDs) have been used in backlight modules to gradually replace the conventional cold cathode fluorescent lamps (CCFLs) as a primary choice.

Currently, a backlight module typically comprises a plurality of LEDs, a printed circuit board (PCB), an aluminum extruded piece and a backplate. The LEDs are soldered on the PCB, and the PCB makes contact with the aluminum extruded piece which, in turn, makes contact with the backplate. Heat generated by the LEDs during operation is transferred via the PCB to the aluminum extruded piece and then from the aluminum extruded piece to the backplate so as to be dissipated outwards. The backlight module of this structure primarily has the following problems in terms of heat dissipation.

Firstly, the heat dissipation efficiency is affected by dimensions (e.g., the length, the width and the height) of the aluminum extruded piece, but the dimensions of the aluminum extruded piece is greatly restricted by the available internal space inside the backlight module.

Secondly, the backlight module usually further comprises a light guide plate and optical films, so an enclosed space is usually formed after assembly of the backlight module. This makes it difficult for the heat to be dissipated through convection between the aluminum extruded piece and the ambient air outside the backlight module, thus degrading the heat dissipation efficiency of the backlight module.

### SUMMARY OF THE INVENTION

The primary objective of the present disclosure is to provide a backlight module with improved heat dissipation efficiency.

To achieve the aforesaid objective, the present disclosure provides a backlight module, which comprises a light source device, a heat dissipating device and a backplate.

The heat dissipating device is disposed between the light source device and the backplate and makes contact with the light source device and the backplate respectively. The light source device comprises a plurality of point light sources and a printed circuit board (PCB) on which the point light sources are disposed respectively; the heat dissipating device comprises a heat dissipating body and a plurality of heat dissipating units disposed on the heat dissipating body respectively; and the backplate comprises a plurality of openings and a plurality of hollowed patterns, the plurality of hollowed patterns are disposed adjacent to the plurality of openings respectively and corresponding to the plurality of heat dissipating units respectively, and the plurality of heat dissipating units extend through the plurality of openings respectively.

In a preferred embodiment of the present disclosure, the heat dissipating body is of a rectangular flat plate structure.

In a preferred embodiment of the present disclosure, the heat dissipating body is located between the light source device and the plurality of openings.

In a preferred embodiment of the present disclosure, the plurality of heat dissipating units are formed integrally with the heat dissipating body.

In a preferred embodiment of the present disclosure, the plurality of heat dissipating units are formed on the heat dissipating body through stamping or chemical etching.

In a preferred embodiment of the present disclosure, the plurality of heat dissipating units are heat dissipating fins.

In a preferred embodiment of the present disclosure, the plurality of heat dissipating units extend through the plurality of openings respectively and are exposed outside the backplate.

To achieve the aforesaid objective, the present disclosure further provides a backlight module, which comprises a light source device, a heat dissipating device and a backplate. The heat dissipating device is disposed between the light source device and the backplate and makes contact with the light source device and the backplate respectively. The heat dissipating device comprises a heat dissipating body and a plurality of heat dissipating units disposed on the heat dissipating body respectively. The backplate comprises a plurality of openings, through which the plurality of heat dissipating units extend respectively.

In a preferred embodiment of the present disclosure, the heat dissipating body is of a rectangular flat plate structure.

In a preferred embodiment of the present disclosure, the heat dissipating body is located between the light source device and the plurality of openings.

In a preferred embodiment of the present disclosure, the light source device comprises a plurality of point light sources and a PCB on which the point light sources are disposed respectively.

In a preferred embodiment of the present disclosure, the plurality of heat dissipating units are formed integrally with the heat dissipating body.

In a preferred embodiment of the present disclosure, the plurality of heat dissipating units are formed on the heat dissipating body through stamping or chemical etching.

In a preferred embodiment of the present disclosure, the plurality of heat dissipating units are heat dissipating fins.

In a preferred embodiment of the present disclosure, the plurality of heat dissipating units extend through the plurality of openings respectively and are exposed outside the backplate.

In a preferred embodiment of the present disclosure, the backplate comprises a plurality of hollowed patterns, which are disposed adjacent to the plurality of openings respectively and corresponding to the plurality of heat dissipating units respectively. To achieve the aforesaid objective, the present disclosure further provides a liquid crystal display (LCD) device, which comprises a backlight module. The backlight module comprises a light source device, a heat dissipating device and a backplate. The heat dissipating device is disposed between the light source device and the backplate and makes contact with the light source device and the backplate respectively. The heat dissipating device comprises a heat dissipating body and a plurality of heat dissipating units disposed on the heat dissipating body respectively. The backplate comprises a plurality of openings, through which the plurality of heat dissipating units extend respectively.

The present disclosure has the following benefits as compared to the prior art: a plurality of heat dissipating units are formed on the heat dissipating body in the backlight module and the LCD device of the embodiments of the present disclosure, so the heat dissipation area of the heat dissipating device is increased and the heat dissipation efficiency of the backlight module is improved without the need of additionally disposing other heat dissipating components outside the backlight module; and moreover, the heat dissipating units are exposed outside through openings of the backplate to dissipate heat outwards directly, so the heat dissipation efficiency of the backlight module is further improved.

### BRIEF DESCRIPTION OF THE DRAWINGS

In order to more clearly describe the technical solutions of the embodiments of the present disclosure, attached drawings to be used in the detailed description of the disclosure will be briefly described hereinbelow. Obviously, the attached drawings described hereinbelow only illustrate some of the embodiments of the present disclosure, and those of ordinary skill in the art can also obtain other attached drawings therefrom without the need of making inventive efforts, wherein:

FIG. 1 is a schematic structural side view of a backlight module according to a preferred embodiment of the present disclosure;

FIG. 2 is a schematic structural plan view of the backlight module shown in FIG. 1 along a line AB; and

FIG. 3 is a schematic structural side view of an LCD device according to a preferred embodiment of the present disclosure.

### DETAILED DESCRIPTION OF THE INVENTION

Various embodiments of the disclosure are now described in detail. Referring to the drawings, like numbers indicate like parts throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

Hereinbelow, the technical solutions of embodiments of the present disclosure will be described clearly and completely with reference to the attached drawings. Obviously, the embodiments described herein are only some of the embodiments of the present disclosure but do not represent all embodiments of the disclosure. All other embodiments that can be devised by those of ordinary skill in the art on the basis of the embodiments described herein and without making inventive efforts shall fall within the scope of the present disclosure.

A backlight module is disclosed in embodiments of the present disclosure.

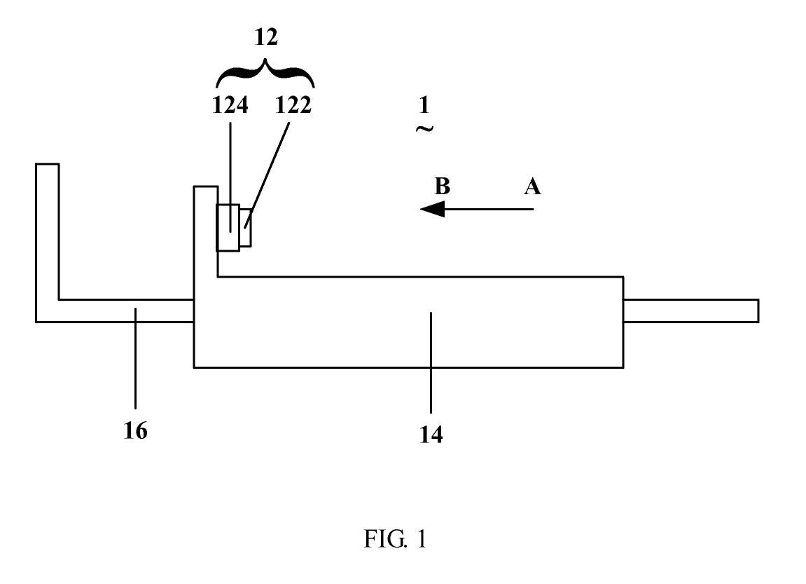

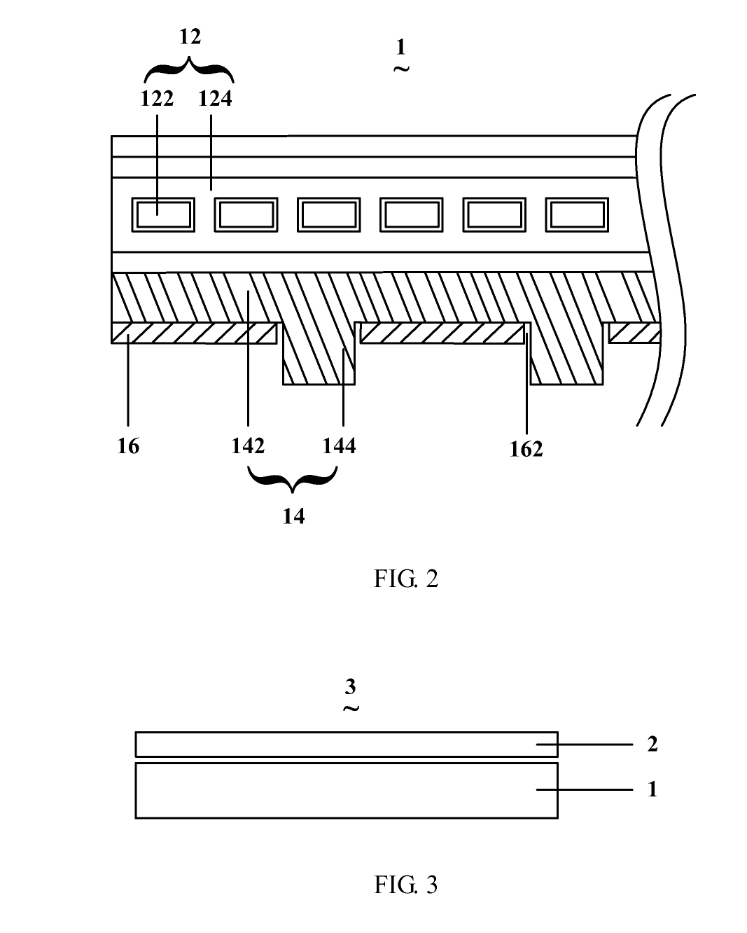

Referring to FIG. 1 and FIG. 2 together, FIG. 1 is a schematic structural side view of a backlight module according to a preferred embodiment of the present disclosure, and FIG. 2 is a schematic structural plan view of the backlight module shown in FIG. 1 along a line AB.

The backlight module 1 comprises a light source device 12, a heat dissipating device 14 and a backplate 16. The heat dissipating device 14 is disposed between the light source device 12 and the backplate 16 and makes contact with the light source device 12 and the backplate 16 respectively. The heat dissipating device 14 comprises a heat dissipating body 142 and a plurality of heat dissipating units 144 disposed on the heat dissipating body 142 respectively. The backplate 16 comprises a plurality of openings 162, through which the plurality of heat dissipating units 144 extend respectively.

The light source device 12 is mainly used to provide light rays having an adequate brightness, and comprises a plurality of point light sources 122 and a circuit board 124 on which the point light sources 122 are disposed respectively. For example, the point light sources 122 may be arranged on the circuit board 124 linearly or in the form of an array, or may be arranged on the circuit board 124 in other appropriate ways depending on practical requirements. In this embodiment, the circuit board 124 may be a printed circuit board (PCB), the point light sources 122 may be light emitting diodes (LEDs) and be soldered on the circuit board 124, and the circuit board 124 is electrically connected with a power supply (not shown).

The backplate 16 is mainly used to keep the physical strength of the backlight module 1, support components inside the backlight module 1, and dissipate heat generated in the backlight module 1 outwards. The backplate 16 is made of a metal or an alloy. For example, the backplate 16 may be made of aluminum (Al), iron (Fe), magnesium (Mg) or an alloy thereof through extrusion or in other ways.

Further, on condition that an adequate physical strength of the backplate 16 can be guaranteed, the backplate 16 may further be provided with a plurality of hollowed patterns (not shown), and the plurality of hollowed patterns are disposed adjacent to the plurality of openings 162 respectively and corresponding to the plurality of heat dissipating units 144 respectively. The plurality of hollowed patterns can promote circulation of the air at both sides of the backplate 16 so as to improve the heat dissipation efficiency of the backlight module 1 more effectively.

The heat dissipating device 14 is made of materials with a good thermal conductivity, for example, the heat dissipating device 14 may be made of aluminum (Al) or an aluminum alloy through extrusion. The heat dissipating body 142 is a rectangular flat plate structure, and is located between the light source device 12 and the plurality of openings 162. The plurality of heat dissipating units 144 are formed integrally with the heat dissipating body 142. For example, the plurality of heat dissipating units 144 may be formed on the heat dissipating body 142 through stamping or chemical etching. The plurality of heat dissipating units 144 formed on the heat dissipating body 142 can increase the effective heat dissipation area of the heat dissipating device 14 so as to improve the heat dissipation capability of the heat dissipating device 14.

Further, the plurality of heat dissipating units 144 extend outwards from the heat dissipating body 142 and through the plurality of openings 162 respectively, and are exposed outside the backplate 16. The plurality of heat dissipating units 144 may be heat dissipating fins, and the form thereof is not limited; for example, the heat dissipating units 144 may be in a fin scale form, a rectangular form, an elliptical form, a triangular form, a circular form or some other appropriate polygonal form.

The backlight module 1 dissipates heat in the following way: heat generated by the point light sources 122 is transferred to the heat dissipating body 142 of the heat dissipating device 14 via the circuit board 124, then transferred from the heat dissipating body 142 of the heat dissipating device 14 to the backplate 16, and is finally dissipated outwards by the backplate 16. Furthermore, heat transferred to the heat dissipating device 14 can be further transferred by the heat dissipating units 144 of the heat dissipating device 14 to the outside of the backplate 16 directly, so the heat dissipation capability is further improved.

A liquid crystal display (LCD) device is further disclosed. Referring to FIG. 3, the LCD device 3 comprises the backlight module 1 and an LCD panel 2. The LCD panel 2 is disposed in front of the backlight module 1 so that the LCD panel 2 can be illuminated by light emitted from the backlight module 1 to display images. The LCD device 3 may be an LCD or an LCD TV set.

The present disclosure has the following benefits as compared to the prior art:

because a plurality of heat dissipating units 144 are formed on the heat dissipating body 142 in the backlight module 1 and the LCD device 3 comprising the backlight module 1 of the present disclosure, the heat dissipation area of the heat dissipating device 14 is increased and the heat dissipation efficiency of the backlight module 1 is improved. Furthermore, the heat dissipating units 144 are exposed outside through the openings 162 of the backplate 16 to dissipate heat outwards directly, so the heat dissipation efficiency of the backlight module 1 is further improved. Moreover, the hollowed patterns of the backplate 16 corresponding to the heat dissipating units 144 can promote circulation of the air between the inside and the outside of the backplate 16, which further improves the heat dissipation efficiency of the backlight module 1. Thereby, heat generated by the light source device 12 can be dissipated outside the backlight module 1 timely without the need of additionally disposing other heat dissipating components outside the backlight module 1, so the whole structure of the backlight module 1 is simplified and the additional production cost incurred by additionally disposing other heat dissipating components is saved.

Accordingly, the backlight module and the LCD device of the embodiments of the present disclosure have high heat dissipation efficiency.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

1. A backlight module, comprising a light source device, a heat dissipating device and a backplate, and the heat dissipating device being disposed between the light source device and the backplate and making contact with the light source device and the backplate respectively, wherein:
the light source device comprises a plurality of point light sources and a printed circuit board (PCB) on which the point light sources are disposed respectively;
the heat dissipating device comprises a heat dissipating body and a plurality of heat dissipating units disposed on the heat dissipating body respectively; and
the backplate comprises a plurality of openings and a plurality of hollowed patterns, the plurality of hollowed patterns are disposed adjacent to the plurality of openings respectively and corresponding to the plurality of heat dissipating units respectively, and the plurality of heat dissipating units extend through the plurality of openings respectively.

2. The backlight module of claim 1, wherein the heat dissipating body is of a rectangular flat plate structure.

3. The backlight module of claim 1, wherein the heat dissipating body is located between the light source device and the plurality of openings.

4. The backlight module of claim 1, wherein the plurality of heat dissipating units are formed integrally with the heat dissipating body.

5. The backlight module of claim 4, wherein the plurality of heat dissipating units are formed on the heat dissipating body through stamping or chemical etching.

6. The backlight module of claim 1, wherein the plurality of heat dissipating units are heat dissipating fins.

7. The backlight module of claim 1, wherein the plurality of heat dissipating units extend through the plurality of openings respectively and are exposed outside the backplate.

8. A backlight module, comprising a light source device, a heat dissipating device and a backplate, and the heat dissipating device being disposed between the light source device and the backplate and making contact with the light source device and the backplate respectively, wherein: the heat dissipating device comprises a heat dissipating body and a plurality of heat dissipating units disposed on the heat dissipating body respectively; and the backplate comprises a plurality of openings, through which the plurality of heat dissipating units extend respectively.

9. The backlight module of claim 8, wherein the heat dissipating body is of a rectangular flat plate structure.

10. The backlight module of claim 8, wherein the heat dissipating body is located between the light source device and the plurality of openings.

11. The backlight module of claim 8, wherein the plurality of heat dissipating units are formed integrally with the heat dissipating body.

12. The backlight module of claim 11, wherein the plurality of heat dissipating units are formed on the heat dissipating body through stamping or chemical etching.

13. The backlight module of claim 8, wherein the plurality of heat dissipating units are heat dissipating fins.

14. The backlight module of claim 8, wherein the plurality of heat dissipating units extend through the plurality of openings respectively and are exposed outside the backplate.

15. The backlight module of claim 8, wherein the backplate comprises a plurality of hollowed patterns, which are disposed adjacent to the plurality of openings respectively and corresponding to the plurality of heat dissipating units respectively.

16. The backlight module of claim 8, wherein the light source device comprises a plurality of point light sources and a printed circuit board (PCB) on which the point light sources are disposed respectively.

17. A liquid crystal display (LCD) device, comprising the backlight module of claim 1.
